(19) United States
(12) Patent Application Publication
(10) Pub. No.: US 2026/0173036 A1
(43) Pub. Date: Jun. 18, 2026

(54) First Network Node, Second Network Node, and Methods Performed Thereby for Handling Downlink Transmission for a Wireless Device

(71) Applicant: Telefonaktiebolaget LM Ericsson (publ), Stockholm (SE)

(72) Inventors: Andreas Höglund, Solna (SE); Revathy Narayanan, Sollentuna (SE); Jan Christoffersson, Luleå (SE); Luca Feltrin, Solna (SE)

(21) Appl. No.: 19/125,947

(22) PCT Filed: Nov. 2, 2022
(86) PCT No.: PCT/SE2022/051004

§ 371 Date: Apr. 30, 2025

(51) Int. Cl. H04W 68/02

(52) U.S. Cl. CPC H04W 68/02

(57) ABSTRACT

A method by a first network node (111), for handling downlink transmission for a wireless device (130). The first network node (111) operates in a RAN (110). The first network node (111) obtains (201) data for transmission to the device (130). The first network node (111) has a context for the device (130). The device (130) is in inactive state. The first network node (111) sends (203) a first indication to a second network node (112) operating in the RAN (110) and to page or be paging the device (130) for the transmission. The indication indicates a size of the data. The first network node (111) refrains from sending the indication to other network nodes (113) operating in the RAN (110). The sending (203) of the indication is performed with the proviso that a previous indication has been obtained from the second network node (112) indicating the device (130) is in its serving area.

### TECHNICAL FIELD

The present disclosure relates generally to a first network node, and methods performed thereby, for handling downlink transmission for a wireless device. The present disclosure also relates generally to a second network node and methods performed thereby for handling the downlink transmission for the wireless device.

### BACKGROUND

Wireless devices within a wireless communications network may be e.g., User Equipments (UEs), stations (STAs), mobile terminals, wireless terminals, terminals, and/or Mobile Stations (MS). Wireless devices may be enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, a radio base station in New Radio (NR), evolved Node B (“eNB”), “eNodeB”, “NodeB” or “B node”, a radio base station in Long Term Evolution (LTE), Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations may communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network, which may be referred to as Next Generation (NG) Core Network (CN), abbreviated as NG-CN, NGC or 5G CN. NG may be understood to be the interface/reference point between the RAN and the CN in 5G/NR.

### Internet of Things (IoT)

The Internet of Things (IoT) may be understood as an internetworking of communication devices, e.g., physical devices, vehicles, which may also be referred to as “connected devices” and “smart devices”, buildings and other items—embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices are expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that may be understood to be a self and/or automatically controlled unattended machine and that may be understood to be typically not associated with an active human user in order to generate data traffic. An MTC device may be typically simpler, and typically associated with a more specific application or purpose, than, and in contrast to, a conventional mobile phone or smart phone. MTC may be understood to involve communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

4-Step Random Access procedure

A 4-step approach may be used for the random-access procedure. In this approach, a User Equipment (UE) may detect synchronization signals (SSs) and decode the broadcasted system information. The UE may then, in message 1, transmit a Physical Random Access Channel (PRACH) preamble in the uplink. The gNB may reply with a Random Access Response (RAR), message 2. The UE may then transmit a UE identification in message 3 on the Physical Uplink Shared Channel (PUSCH) using an uplink grant, that is, an allocation of uplink transmission resources. Finally, the gNB may then transmit a Contention Resolution Message (CRM) in message 4.

2-step Random Access Procedure

With the 2-step procedure the random access may be understood to be completed in only two steps. In Step 1, the UE may send a message A including a random access preamble together with higher layer data such as Radio Resource Control (RRC) connection request, possibly with some small payload on PUSCH, denoted “msgA PUSCH”. The msgA PUSCH may be used for small data transmissions in inactive. In Step 2, the gNB may send a response called message B, which may be described as a modified RAR, including UE identifier assignment, timing advance information, and contention resolution message etc. In addition, message B (msgB) may contain a higher layer part. The msgB may be understood as a response to msgA, which may contain contention resolution message(s), fallback indication(s) to schedule Msg3 transmission, and backoff indication.

### NR Small Data Transmissions in Inactive State

In Rel-17, mobile originated small data transmission (MO-SDT) was introduced for NR to reduce the signaling overhead for small uplink data payloads, see RP-200954 ‘New Work Item on NR small data transmissions in INACTIVE state’. Two approaches were introduced, random access based SDT (RA-SDT) and configured grant SDT (CG-SDT). RA-SDT may be understood to mean that either legacy 4-step Random Access CHannel (RACH), or 2-step RACH, procedure may be used as a baseline, but that a user-plane data payload may be appended, e.g., multiplexed with the RRCResumeRequest message, in Msg3, or MsgA. CG-SDT may be understood to mean that the UEs may be configured via Radio Resource Control (RRC) to have periodic CG-SDT occasions which may, contention-free, be used for uplink transmission. In this way, Msg1 and Msg2 may be omitted, but it may be understood to be a requirement that the UE have a valid Timing Advance (TA), and is uplink synchronized to be able to use the resources for transmission.

For NarrowBand IoT (NB-IoT) and LTE for machine type communication (LTE-M), similar signaling optimizations for small data have been introduced through Rel-15 Early Data Transmission (EDT) and Rel-16 Preconfigured Uplink Resources (PUR). The main differences for the NR Small Data Transmissions (SDT) approaches may be understood to be that the Rel-17 NR Small Data may only be supported for Radio Resource Control (RRC) INACTIVE state, may include also 2-step RACH based small data, that it may be supported by any NR UE, e.g., also Mobile BroadBand (MBB) UEs and not limited to IoT UEs, and support transmission of subsequent data, e.g., larger payload sizes which may require more than one transmission.

For LTE, support for mobile terminate (MT) was later introduced in Rel-16, that is, supporting transmissions of small data payloads in the downlink. Several approaches were considered: ‘Data in paging’, multiple versions, ‘Data in Msg2’, and ‘Data in Msg4’. An overview is provided in the RAN2 email discussion R2-1901143 from RAN2 #105. ‘Data in paging’ was first ruled out, see meeting report R2-1903001, and later ‘Data in Msg2’ was ruled out, see User Plane (UP) MT-EDT email discussion outcome in R2-1910420, and meeting report in R2-1912001, and therefore ‘Data in Msg4’ was specified as the LTE approach. It may be noted that for NB-IoT and LTE-M, different approaches were introduced for the IoT control-plane optimization, ‘Data over NAS’, or DoNAS, and IoT user-plane optimizations, RRC suspend/resume, Control Plane (CP)-EDT and UP-EDT, respectively, and that the NR approaches resembles the UP-EDT.

Currently, Mobile Terminated Small Data Transmission (MT-SDT) is being introduced in Rel-18 for NR. That is, transmission of small amounts of data to a user equipment in inactive state. However, no methods have been yet specified. A Rel-18 MT-SDT work item description (WID) was approved in RAN #94e (December 2021) and may be found in RP-213583. The WID contains as one of the objectives to specify the support for paging-triggered SDT, that is, MT-SDT. A particular objective was to specify the MT-SDT triggering mechanism for UEs in RRC_INACTIVE, supporting RA-SDT and CG-SDT as the UL response. Another particular objective was to specify the MT-SDT procedure for initial DL data reception and subsequent UL/DL data transmissions in RRC_INACTIVE. Data transmission in DL within a paging message was not in scope of this WI.

### SUMMARY

As part of the development of embodiments herein, one or more challenges with the existing technology will first be identified and discussed.

An approach to provide support for MT-SDT may be a decentralized approach, where a paging gNB may determine whether to use MT-SDT for the transmission of the DL data payload to the UE or not. That is, the anchor gNB may receive the DL data, e.g., from the User Plane Function (UPF), and may initiate paging. Since, as stated above, MT-SDT may only be supported in RRC_INACTIVE state, RAN paging where the anchor gNB may be understood to be responsible for the paging may be the only relevant case, and not Core Network (CN) paging with Access and Mobility Management Function (AMF) control. Based on a comparison of the data payload size and the MT-SDT data volume threshold, and the MT-SDT capability of the UE, each paging gNB may determine to use MT-SDT for the transmission or not. The anchor gNB may decide for its own cells, and for paging in other gNBs in the registration area it may be up to the target gNBs to use MT-SDT or not. The problem is that target gNBs need to know the size of the data in order to know whether it falls below the MT-SDT data volume threshold, such that MT-SDT may be used. The MT-SDT data volume threshold may be specified to be cell-specific and separately configured by each gNB. Therefore, a Data Volume Indication (DVI), indicating the data payload size, may be understood to have to be communicated from the anchor gNB to all target gNBs involved in the paging, potentially the entire RAN registration area, over the Xn interface. This may be understood to be unwanted, given the high overhead it may generate.

According to the foregoing, it is an object of embodiments herein to improve the handling downlink transmission for a wireless devices in a wireless communications network.

Embodiments herein may be understood to relate to a late data volume indication in MT-SDT. That is, in embodiments herein, the Data Volume Indication may be delayed with respect to the description provided above, where it may be transmitted in the paging message over Xn to all gNBs. Instead, in embodiments herein, the DVI may be transmitted only to the gNB which may receive a Random Access from the UE for which the downlink transmission may be intended, in response to the paging. In other words, embodiments herein may be understood to intend to restrict the transmission of the Data Volume Indication only to the paging gNB where the UE may be located.

According to a first aspect of embodiments herein, the object is achieved by a method, performed by a first network node. The method is for handling downlink transmission for a wireless device. The first network node operates in a RAN of a wireless communications network. The first network node obtains data for downlink transmission to the wireless device. The first network node has a context stored for a connection with the wireless device. The wireless device is in an inactive state. The first network node then sends a first indication to a second network node. The second network node operates in the RAN of the wireless communications network and is to page or be paging the wireless device for transmission of the data. The first indication indicates a size of a buffer of the data for downlink transmission to the wireless device. The first network node refrains from sending the first indication to other network nodes operating in the RAN of the wireless communications network and paging the wireless device for transmission of the data. The sending of the first indication is performed with the proviso that a previous indication has been obtained from the second network node indicating the wireless device is in the serving area of the second network node.

According to a second aspect of embodiments herein, the object is achieved by a method, performed by the second network node. The method is for handling downlink transmission for the wireless device. The second node operates in the RAN of the wireless communications network. The second network node receives the first indication from the first network node operating in the RAN of the wireless communications network. The first indication indicates a size of the buffer of data for the downlink transmission to the wireless device. The wireless device is located in the serving area of the second network node. The wireless device is in the inactive state. The receiving of the first indication is performed with the proviso that the previous indication has been sent by the second network node indicating that the wireless device is in the serving area of the second network node.

According to a third aspect of embodiments herein, the object is achieved by the first network node, for handling downlink transmission for the wireless device. The first network node is configured to operate in the RAN of the wireless communications network. The first network node is further configured to obtain the data for downlink transmission to the wireless device. The first network node is configured to have the context stored for the connection with the wireless device. The wireless device is configured to be in the inactive state. The first network node is also configured to send the first indication to the second network node. The second network node is configured to operate in the RAN of the wireless communications network and to page or be paging the wireless device for transmission of the data. The first indication is configured to indicate the size of the buffer of the data for downlink transmission to the wireless device. The first network node is configured to refrain from sending the first indication to the other network nodes configured to operate in the RAN of the wireless communications network and configured to be paging the wireless device for transmission of the data. The sending of the first indication is configured to be performed with the proviso that the previous indication is configured to have been obtained from the second network node indicating the wireless device is in the serving area of the second network node.

According to a fourth aspect of embodiments herein, the object is achieved by the second network node, for handling downlink transmission for the wireless device. The second network node is configured to operate in the RAN of the wireless communications network. The second network node is further configured to receive the first indication from the first network node. The first network node is configured to operate in the RAN of the wireless communications network. The first indication is configured to indicate the size of the buffer of the data for the downlink transmission to the wireless device. The wireless device is configured to be located in the serving area of the second network node. The wireless device is configured to be in the inactive state. The receiving of the first indication is configured to be performed with the proviso that the previous indication is configured to have been sent by the second network node. The previous indication is configured to indicate that the wireless device is in the serving area of the second network node.

By the first network node sending the first indication to the second node while refraining from sending it to the other network nodes, the first network node may enable the data to be transmitted to the wireless device in inactive state, with all the benefits this involves, and in addition to do it while enabling to minimize signaling over the Xn interface.

By the second network node receiving the first indication from the first network node with the proviso that the previous indication has been sent by the second network node indicating that the wireless device is in the serving area of the second network node, the first network node may be enabled to refrain from sending the first indication to the other nodes. Hence, the second network node and the first network node may enable the data to be transmitted to the wireless device in inactive state, with all the benefits this involves, and in addition to do it while enabling to minimize signaling over the Xn interface.

### BRIEF DESCRIPTION OF THE DRAWINGS

Examples of embodiments herein are described in more detail with reference to the accompanying drawings, and according to the following description.

FIG. 1 is a schematic diagram illustrating a wireless communications network, according to embodiments herein.

FIG. 2 is a flowchart depicting an example of a method in a first network node, according to embodiments herein.

FIG. 3 is a flowchart depicting an example of a method in a second network node, according to embodiments herein.

FIG. 4 is a flowchart depicting an example of a method of a baseline approach, with respect to to embodiments herein.

FIG. 5 is a schematic representation depicting a non-limiting example of methods according to embodiments herein.

FIG. 6 is a schematic representation depicting another non-limiting example of methods according to embodiments herein.

FIG. 7 is a schematic block diagram illustrating two non-limiting examples, a) and b), of a first network node, according to embodiments herein.

FIG. 8 is a schematic block diagram illustrating two non-limiting examples, a) and b), of a second network node, according to embodiments herein.

FIG. 9 shows an example of a communication system 900 in accordance with some embodiments.

FIG. 10 is a block diagram of a host 1000, which may be an embodiment of the host 916 of FIG. 9, in accordance with various aspects described herein.

FIG. 11 shows a communication diagram of a host 1102 communicating via a network node 1104 with a UE 1106 over a partially wireless connection in accordance with some embodiments.

### DETAILED DESCRIPTION

Certain aspects of the present disclosure and their embodiments may provide solutions to the challenge described in the Summary section, or other challenges. There are, proposed herein, various embodiments which address one or more of the issues disclosed herein.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other, newer, wireless systems with similar features, may also benefit from exploiting the ideas covered within this disclosure.

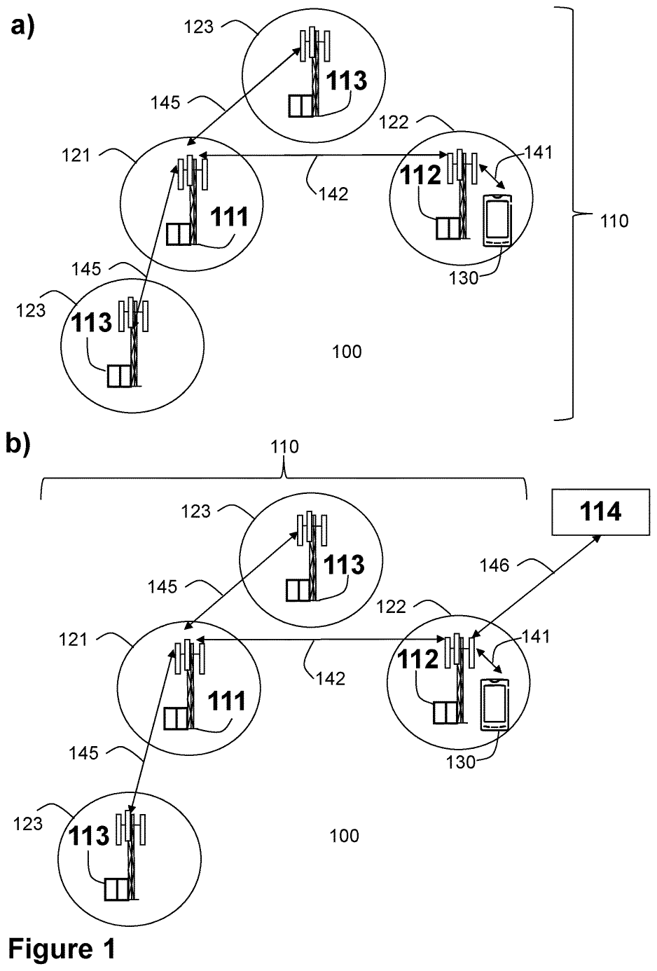

FIG. 1 depicts two non-limiting examples, on panel a) and panel b), respectively, of a wireless communications network 100, sometimes also referred to as a communications network, wireless communications system, cellular radio system, or cellular network, in which embodiments herein may be implemented. The wireless communications network 100 may typically be a 5G system, 5G network, NR-U or Next Gen System or network, LAA, MulteFire. The wireless communications network 100 may support a newer system than a 5G system, such as, for example a 6G system. The wireless communications network 100 may support other technologies, such as, for example Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, etc. . . . . Other examples of other technologies the communications network 100 may support may be Wideband Code Division Multiple Access (WCDMA), Universal Terrestrial Radio Access (UTRA) TDD, Global System for Mobile Communications (GSM) network, Enhanced Data Rates for GSM Evolution (EDGE) network, GSM EDGE Radio Access Network (GERAN) network, Ultra-Mobile Broadband (UMB), network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, Narrowband Internet of Things (NB-IoT), or any cellular network or system. Thus, although terminology from 5G/NR and LTE may be used in this disclosure to exemplify embodiments herein, this should not be seen as limiting the scope of the embodiments herein to only the aforementioned systems.

The wireless communications network 100 comprises a Radio Access Network (RAN), 110. The RAN 100 comprises a plurality of network nodes, whereof a first network node 111 and a second network node 112 and other network nodes 113, which may be understood to be third network nodes, are depicted in the non-limiting examples of FIG. 1. In the examples of FIG. 1, the other network nodes 113 are represented as comprising two different network nodes. However, it may be understood that this is for illustrative purposes only, and that the other network nodes 113 may comprise further, or fewer network nodes than those represented in FIG. 1. In some embodiments, such as that depicted in panel b) of FIG. 1, the wireless communications network 100 may comprise a fourth network node 114. Any of the first network node 111, the second network node 112, the other network nodes 113 and the fourth node 114 may be a radio network node, wherein the first network node 111 may be a first radio network node, the second network node 112 may be a second radio network node, and each of the other network nodes 113 may be a third radio network node. That is, any of the first network node 111, the second network node 112, the other network nodes 113 and the fourth node 114 may be a transmission point such as a radio base station, for example a gNB, an eNB, or any other network node with similar features capable of serving a wireless device, such as a user equipment or a machine type communication device, in the wireless communications network 100. In particular embodiments, the first network node 111 may be a first gNB. The second network node 112 may be a second gNB. Any of the other network nodes 113 and the fourth node 114 may be other gNBs. In other examples, which are not depicted in FIG. 1, any of the first network node 111, the second network node 112, the other network nodes 113 and the fourth node 114 may be a distributed node, such as a virtual node in the cloud, and may perform its functions entirely on the cloud, or partially, in collaboration with a radio network node. In some examples, the first network node 111 may be also referred to herein as an anchor node, and any of the second network node 112 and the other network nodes 113 may be referred to herein as paging nodes.

The wireless communications network 100 covers a geographical area which may be divided into cell areas, wherein each cell area may be served by a network node, although, one radio network node may serve one or several cells. The wireless communications network 100 may comprise a first cell 121, which may be served by the first network node 111. The wireless communications network 100 may also comprise a second cell 122, which may be served by the second network node 112. In some embodiments, the wireless communications network 100 may further comprise a respective third cell 123, which may be served by a respective network node of the other network nodes 113. In examples wherein the fourth network node 114 may be a radio network node, it may also serve a respective fourth cell.

Any of the first network node 111, the second network node 112, the other network nodes 113 and the fourth node 114 may serve additional cells. This is not depicted in FIG. 1 to simplify the figure.

Any of the first network node 111, the second network node 112, the other network nodes 113 and the fourth node 114 may be of different classes, such as, e.g., macro base station, home base station or pico base station, based on transmission power and thereby also cell size.

Any of the first network node 111, the second network node 112, the other network nodes 113 and the fourth node 114 may support one or several communication technologies, and its name may depend on the technology and terminology used. In 5G/NR, any of the first network node 111 and the second network node 112 may be referred to as a gNB and may be directly connected to one or more core networks.

In some embodiments, such as that depicted in panel b) of FIG. 1, the fourth network node 114 may be a core network node, such as for example, a User Plane Function (UPF).

A wireless device 130 may be comprised in the wireless communication network 100. The wireless device 130 comprised in the wireless communications network 100 may be a wireless communication device, which may also be known as e.g., mobile terminal, wireless terminal and/or mobile station, a mobile telephone, cellular telephone, or laptop with wireless capability, just to mention some further examples. The wireless device 130 comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. In particular embodiments, the wireless device 130 may be a user equipment, such as a 5G UE or nUE, or a UE. The wireless device 130 comprised in the wireless communications network 100 is enabled to communicate wirelessly in the wireless communications network 100. The communication may be performed e.g., via a RAN, and possibly the one or more core networks, which may be comprised within the wireless communications network 100.

The wireless device 130 may be configured to communicate within the wireless communications network 100 with the second network node 112 in the second cell 122 over a first link 141, e.g., a radio link. The first network node 111 and the second network node 112 may be configured to communicate within the wireless communications network 100 over a second link 142, e.g., a wired link, a radio link or an X2 interface. The wireless device 130 may be configured to communicate within the wireless communications network 100 with the first network node 111 in the first cell 121 over a third link, e.g., a radio link. The wireless device 130 may be configured to communicate within the wireless communications network 100 with the other network nodes 113 in the third cell 123 over a respective fourth link, e.g., a radio link. The first network node 111 and the other network nodes 113 may be configured to communicate within the wireless communications network 100 over a respective fifth link 145 e.g., a wired link, a radio link or an X2 interface. The first network node 111 and the fourth network node 114 may be configured to communicate within the wireless communications network 100 over a sixth link 146, e.g., a wired link or a radio link.

In general, the usage of “first”, “second”, “third”, “fourth”, “fifth” and/or “sixth” herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

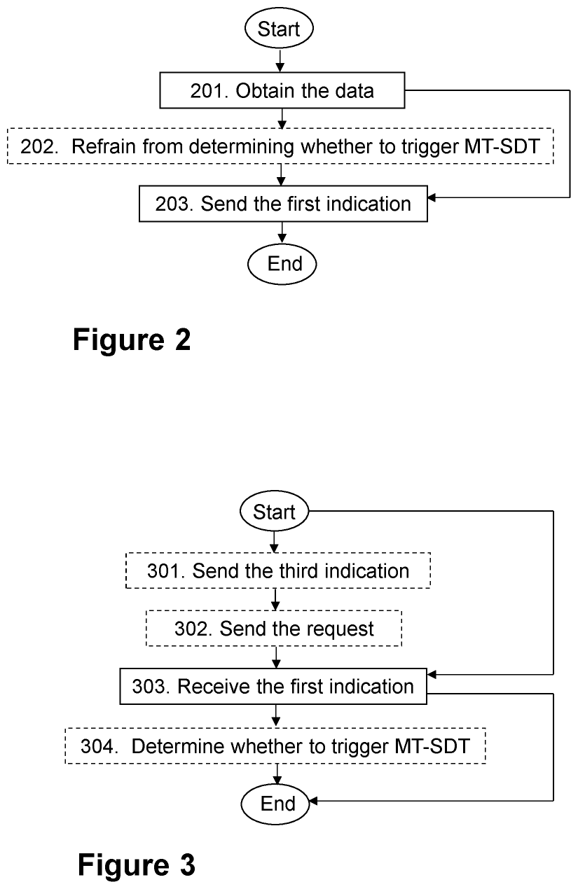

Embodiments of a method performed by the first network node 111 will now be described with reference to the flowchart depicted in FIG. 2. The method may be understood to be for handling downlink transmission for the wireless device 130. The first network node 111 operates in a RAN of the wireless communications network 100.

The wireless communications network 100 may be a Fifth Generation network.

Several embodiments are comprised herein. In some embodiments all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first network node 111 is depicted in FIG. 2. Examples of these actions and the indications which will be described are provided in this document. Some actions may be performed in a different order than that shown FIG. 2.

In FIG. 2, actions which may be optional in some examples are depicted with dashed boxes.

### Action 201

In this Action 201, the first network node 111 obtains data for downlink transmission to the wireless device 130. The first network node 111 may obtain the data from the fourth network node 114, e.g., a core network node operating in the wireless communications network 100, e.g., from a UPF, where the data may have arrived.

The wireless device 130 is in an inactive state. The inactive state may be a Radio Resource Control (RRC) inactive state.

The first network node 111 has a context stored for a connection with the wireless device 130. That is, the first network node 111 may be understood to be an anchor network node to the wireless device 130. This may be understood to mean that the first network node 111 is the network node which the wireless device 130 may have been connected to when it went into inactive state, and therefore, the first network node 111 may have stored the context for the connection it had with the wireless device 130.

The obtaining, e.g., receiving, of the data may be performed, e.g., via the sixth link 146.

After receiving the data for downlink transmission to the wireless device 130, the first network node 111 may page the wireless device 130. The first network node 111 also send a paging request over the Xn interface to the second network node 112 and the other network nodes 113, so that they may initiate paging the wireless device 130. Accordingly, the second network node 112 and the other network nodes 113 mat be referred to herein as paging nodes. In particular examples, the first network node 111 may include, in the paging request, an additional indication, referred to herein a second indication, of a capability of the wireless device 130 to perform a mobile-terminated small data transmission procedure. That is, a procedure to receive a small amount of downlink data while in inactive state.

### Action 202

In this Action 202, the first network node 111 may refrain from determining whether or not to trigger a mobile-terminated small data transmission procedure for transmission of the data towards the wireless device 130. That is, from checking if the size of the data obtained for downlink transmission to the wireless device 130 may be small enough to be delivered to the wireless device 130 in inactive state, without requiring the connection with the wireless device 130 to be re-established. In other words, from checking if the size of the data obtained for downlink transmission to the wireless device 130 may be under a threshold.

The first network node 111 may refrain from this determination until the first network node 111 may receive a further indication indicating whether or not the wireless device 130 is in a serving area of the first network node 111. That is, the first network node 111 may wait to confirm whether or not the wireless device 130 may be located in its coverage area before deciding whether or not to trigger the MT-SDT. If the wireless device 130 is located in the coverage area of a different network node, such as the second network node 112, the first network node 111 may defer the performance of that decision to the network node under the coverage of which the wireless device 130 may be.

If the wireless device 130 is located in an area of coverage of a network node other than the first network node 111, the further indication may be, for example, a Retrieve UE Context request received from the network node under the serving area of which the wireless device 130 may be, which in embodiments herein is the second network node 112, indicating that the wireless device 130 is located in a cell of the second network node 112, such as the second cell 122.

If the wireless device 130 were to be located in the coverage area of the first network node 111, the further indication may have been a Random Access (RA) preamble received from the wireless device 130, e.g., a Contention Free Random Access (CFRA) preamble.

### Action 203

In this Action 203, the first network node 111 sends a first indication to the second network node 112. The second network node 112 is operating in the RAN of the wireless communications network 100 and is to page, or is paging, the wireless device 130 for transmission of the data. That is, the second network node 112 may be understood to be a paging network node. The second network node 112 may be to page the wireless device 130 in cases wherein it may not have yet started to page the wireless device 130, e.g., because the first network node 111 may not yet have requested that it start to do so. In cases wherein the first network node 111 may have already sent a paging request to the second network node 112 to page the wireless device 130, the second network node 112 may be paging the wireless device 130.

The first indication indicates a size of a buffer of the data for downlink transmission to the wireless device 130. The first indication may be a data volume indicator (DVI). The DVI may, in its simplest form, be just an indicator of whether the data may be above a configurable threshold, or it may indicate an approximate level, similar to the Buffer Status Report (BSR) Medium Access Control (MAC) Control Element (CE) or it may indicate the exact data volume, e.g., a number of bits or bytes.

The first network node 111 refrains c. The other network nodes 113 are operating in the RAN of the wireless communications network 100 and paging the wireless device 130 for transmission of the data. However, it may be understood that the wireless device 130 is not in the coverage area of the other network nodes 113, or at least may not have sent a RA preamble trying to connect to any of the other nodes 113 in response to the paging by the other network nodes 113.

The sending in this Action 203 of the first indication is performed with the proviso that a previous indication has been obtained from the second network node 112 indicating the wireless device 130 is in the serving area of the second network node 112. That is, with the embodiments herein, the first indication may be transmitted only to the paging network node, e.g., gNB, where the wireless device 130 may be located, that is, to the network node which may be understood to have received a random access preamble from the wireless device 130 in response to the paging.

The previous indication may be, for example, a Retrieve UE Context request, indicating that the wireless device 130 is located in a cell of the second network node 112, such as the second cell 122.

Accordingly, in some embodiments, the further indication described in Action 202 may be the previous indication indicating the wireless device 130 may be in the serving area of the second network node 112.

In accordance with this, in some embodiments, the first indication may be sent to the second network node 112 along with another indication, of the context of the wireless device 130, in a response to a request for the context received from the second network node 112.

That is, the another indication may be a Retrieve UE Context response. In such embodiments, the first indication may be sent along with the data.

In other embodiments, the first indication may be sent to the second network node 112 before sending the another indication of the context of the wireless device 130, e.g., the Retrieve UE Context response.

In some embodiments, the first indication may be sent to the second network node 112 in one of: a) a paging request, b) the paging request, wherein the paging request may trigger the paging by the second network node 112 of the wireless device 130, and c) the paging request, wherein the paging request may further comprise the second indication of the capability of the wireless device 130 to perform the mobile-terminated small data transmission procedure.

The sending of the first indication may be performed, e.g., via the second link 142.

In some examples, appending the first indication along with the context transfer of the wireless device 130 may be performed once the second network node 112 may receive a paging triggered CFRA preamble from the wireless device 130. To be precise, the second network node 112 may initiate a context transfer of the wireless device 130 once the wireless device 130 may send the CFRA preamble. In this case, the wireless device 130 may also resume the radio bearers (RBs) when transmitting the CFRA preamble. When the second network node 112 may receive the CFRA preamble, it may send a request to the first network node 111 to retrieve the context of the wireless device 130. Compared to the cases when the legacy Retrieve UE Context message may be sent, some changes to the legacy message or a new message may be needed, since the second network node 112 may not have received the RRCResumeRequest from the wireless device 130, which may be needed to construct the Retrieve UE context request such as the ResumeMAC-I. From the paging message, the Inactive Radio Network Temporary Identifier (I-RNTI) identifying the context of the wireless device 130 may be known, and this may form the basis of this new message.

The first network node 111 may then append the first indication to the context of the wireless device 130 transmitted in response to the request context of the wireless device 130 from the second network node 112, where the wireless device 130 may be located.

For the case when CG-SDT may be configured for the UL response, the applicability of embodiments herein may be limited to some specific cases. In legacy UL SDT, CG-SDT may only be configured in the cell where the wireless device 130 may have been released to inactive, that is, the first cell 121. So, if anchor relocation has been performed to this cell during the previous SDT procedure, and the wireless device 130 were to have remained in this cell, no paging in other target cells may have been needed. Anchor relocation may be understood as a process of transfer of a context for a wireless device from an anchor node, to a new serving node, and identifying the new serving node as the new anchor. Target cells may be understood as a set of other cells where the wireless device 130 may be in, if the wireless device 130 is not in the anchor cell. It may be understood that the second cell 122 may be an example of a target cell, but there may be other possible target cells. In case, such as in embodiments herein, the wireless device 130 may have re-selected a new cell, e.g., the second cell 122, the legacy CG-SDT configuration may not be applicable in the new cell. However, in case no anchor relocation may have been performed during the previous SDT procedure, so that the context of the wireless device 130 may be in the old anchor cell and the wireless device 130 may be with CG-SDT resources in the serving cell and the wireless device 130 may remain in the serving cell, the wireless device 130 may need to be paged, over Xn, in the serving cell when initiating an MT-SDT procedure. Another case may be if there are shared CG-SDT resources that may be configured per cell and used by a paged MT-SDT capable UE. In the applicable cases, embodiments herein may be implemented so that the wireless device 130, when receiving a page, may resume the RBs when transmitting the RRCResumeRequest, even if the paging over Uu may not contain any SDT indication.

By the first network node 111 sending the first indication to the second node 112 while refraining from sending it to the other network nodes 113, the first network node 111 may enable the data to be transmitted to the wireless device 130 in inactive state, with all the benefits this involves, and in addition to do it while enabling to minimize signaling over the Xn interface.

Embodiments of a method, performed by the second network node 112, will now be described with reference to the flowchart depicted in FIG. 3. The method may be understood to be for handling the handling downlink transmission for the wireless device 130. The second network node 112 operates in the RAN 110 of the wireless communications network 100.

The wireless communications network 100 may be a Fifth Generation network.

Several embodiments are comprised herein. In some embodiments all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the second network node 112 is depicted in FIG. 3. Examples of these actions and the indications are provided in this document. In FIG. 3, actions which may be optional in some examples are depicted with dashed boxes. Some actions may be performed in a different order than that shown FIG. 3. The detailed description of some of the following corresponds to the same references provided above, in relation to the actions described for the first network node 111 and will thus not be repeated here. For example, the second network node 112 may be a paging network node.

### Action 301

As stated earlier, in particular examples, the first network node 111 may include, in the paging request, an additional indication, referred to herein a second indication, of a capability of the wireless device 130 to perform a mobile-terminated small data transmission procedure. That is, a procedure to receive a small amount of downlink data while in inactive state.

In this Action 301, the second network node 112 may send, based on a received second indication indicating the capability of the wireless device 130 to perform the MT-SDT procedure, a third indication to the wireless device 130. The third indication may indicate that the wireless device 130 is to resume radio bearers.

The third indication may be an MT-SDT indication in a paging message.

The sending of the third indication may be performed, e.g., via the first link 141.

### Action 302

In response to the paging message, the second network node 112 may receive, from the wireless device 130, an RA preamble, e.g., the CFRA preamble, in e.g., the Physical Random Access Channel (PRACH).

In this Action 302, the second network node 112 may send the request for the context to the first network node 111 with the proviso that the second network node 112 has received the random access preamble from the wireless device 130. The request may be, e.g., a Retrieve UE Context message.

The sending of the third indication may be performed, e.g., via the second link 142.

In some embodiments, the sending in this Action 302 of the request may be performed in the absence of having received another request from the wireless device 130 to resume the connection. The another request to resume the connection may be, e.g., an RRCResumeRequest.

### Action 303

In this Action 303, the second network node 112 receives the first indication from the first network node 111 operating in the RAN 110 of the wireless communications network 100. The first network node 111 has a context stored for a connection with the wireless device 130. That is, the first network node 111 may be understood to be the anchor network node to the wireless device 130.

The first indication indicates the size of the buffer of the data for downlink transmission to the wireless device 130. The wireless device 130 is in the inactive state. The inactive state may be the RRC inactive state. The first indication may be the DVI.

The wireless device 130 is located in the serving area of the second network node 112. The receiving in this Action 303 of the first indication may be performed with the proviso that the previous indication has been sent by the second network node 112 indicating that the wireless device 130 is in the serving area of the second network node 112.

In some embodiments, the first indication may be received by the second network node 112 in one of: a) the paging request, b) the paging request, wherein the paging request may trigger the paging by the second network node 112 of the wireless device 130, c) the paging request, wherein the paging request may further comprise the second indication of the capability of the wireless device 130 to perform the mobile-terminated small data transmission procedure, d) before sending the another indication of the context of the wireless device 130, and e) along with the another indication, of the context of the wireless device 130, in the response to the request for the context sent by the second network node 112.

In some embodiments, the first indication may be received by the second network node 112 along with the context of the wireless device 130 in the response to the request for the context sent by the second network node 112.

By the second network node 112 receiving the first indication from the first network node 111 with the proviso that the previous indication has been sent by the second network node 112 indicating that the wireless device 130 is in the serving area of the second network node 112, the first network node 111 may be enabled to refrain from sending the first indication to the other nodes 113. Hence, the second network node 112 and the first network node 111 may enable the data to be transmitted to the wireless device 130 in inactive state, with all the benefits this involves, and in addition to do it while enabling to minimize signaling over the Xn interface.

### Action 304

In this Action 304, the second network node 112 may determine, after having received a paging request from the first network node 111, and based on the size of the data and the first indication, whether or not to trigger the MT-SDT procedure for transmission of the data towards the wireless device 130.

Determining may be understood as e.g., calculating or deciding.

Based on comparison of the first indication, e.g., the DVI, to the MT-SDT data volume threshold that may be configured in the second cell 122, the second network node 112 may then decide to use the MT-SDT procedure or not. In this case, this may correspond to the second network node 112 multiplexing the RRCRelease with the DL data payload or transmitting the DL data only, in case further UL transmissions may be expected. If the MT-SDT procedure is not used, the second network node 112 may instead respond with RRCResume and resume the previous connection. Subsequent DL data transmission is not considered here.

In some embodiments, at least one of the following two options may apply. In a first option, the first indication may be received by the second network node 112 along with the context of the wireless device 130 in the response to the request for the context sent by the second network node 112, and the second network node 112 may perform the determining of Action 304 after the receiving of Action 303 of the first indication. Based on the retrieved context and the first indication, e.g., DVI, from the first network node 111, the second network node 112 may decide whether or not to initiate the MT-SDT procedure by comparing the configured MT-SDT data volume threshold. This may enable the second network node 112 to decide whether to append the DL data with the RA response as part of the MT-SDT procedure. Upon the context retrieval, the MT-SDT data radio bearers may be re-established. A larger Transport Block Size (TBS) may also be provided to the wireless device 130 for transmitting the RRCResumeRequest, which may enable the transmission of UL data as DL response as part of RA/CG/legacy procedure.

In a second option, the sending in Action 302 of the request may be performed in the absence of having received another request from the wireless device 130 to resume the connection.

The second network node 112 may not immediately determine whether or not the MT-SDT procedure may have to be used or not, e.g., based on whether the wireless device 130 may be MT-SDT capable, and the size of the data payload. Instead, the second network node 112 may take the capability for MT-SDT of the wireless device 130 into consideration and continue a generic paging procedure. The third indication, that is, the MT-indication, or resumption indication, may be included, according to Action 301, in the paging message still to indicate that the wireless device 130 is to resume radio bearers early, e.g., as done for Rel-17 MO-SDT when they may be resumed as part of the procedure to transmit the RRCResumeRequest. That is, early compared to legacy connection establishment without SDT. If MT-SDT is not used, this may be understood to mean that the legacy connection establishment may be followed by the wireless device 130, but that radio bearers may be resumed earlier, which may have a minimal impact on the procedure, not that this may be the case only for MT-SDT capable wireless devices. In an alternative approach, the third indication, that is, the MT-indication may always be omitted, but MT-SDT capable wireless devices may always resume radio bearers early if the cell supports MT-SDT according to an indication in system information, or explicit from the MT-SDT configuration in the cell.

The above description may be understood to be based on using legacy RA as the response to paging, but embodiments herein may be understood to similarly also work with using RA-SDT or CG-SDT as the response.

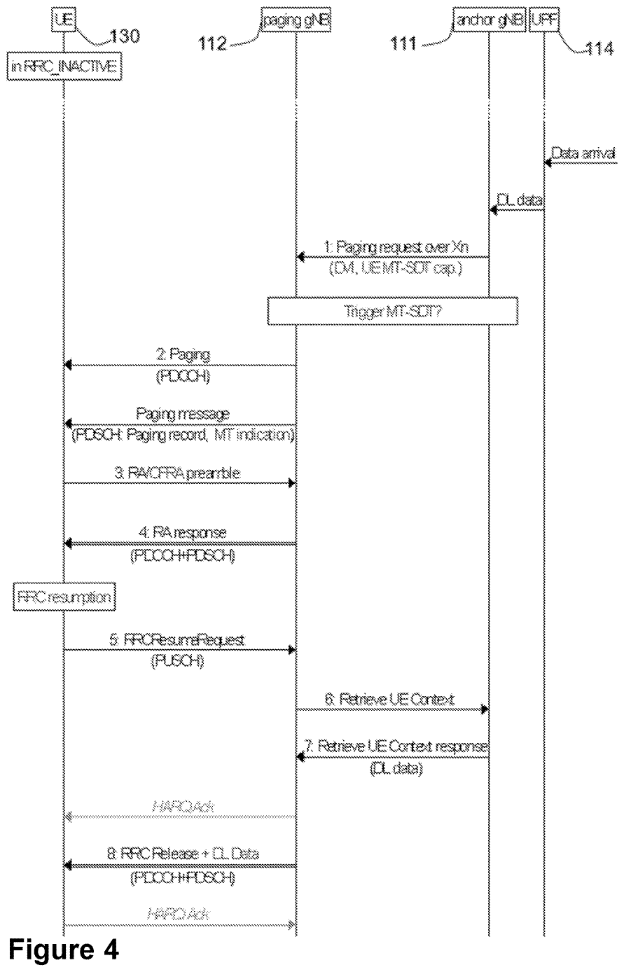

To further understand embodiments herein, it may be helpful to illustrate what may be considered a baseline approach to enable the and MT-SDT procedure, which may be performed in a second set of embodiments, alternative to the embodiments described thus far in relation to FIG. 2 and FIG. 3. FIG. 4 is a schematic representation depicting a non-limiting example of what may be considered such a baseline approach. As depicted in FIG. 4, in such baseline approach, data may arrive for delivery to the wireless device 130, which may be in inactive state. In this example, in RRC_inactive state. In this example, the data may arrive at the fourth network node 114, in this example, a UPF. The fourth network node 114 may deliver the DL data to the first network node 111 storing a context for the wireless device 130, that is, the anchor network node, which in this example is an anchor gNB. The first network node 111 may obtain the data and then send a paging request in step 1, over the Xn interface, to the second network node 112. The first network node 111 may include the first indication, here the DVI, in a paging request to all non-anchor network nodes, here, gNBs. That is, the second network node 112, depicted in FIG. 4, and the other network nodes 113, not depicted. The paging request sent in step 1 may further comprise the second indication of the capability of the wireless device 130 to perform MT-SDT, an “MT-SDT” indication. After this, either the first network node 111 or the second network node 112 may determine whether or not to trigger an MT-SDT procedure. In Step 2, the second network node 112 may page the wireless device 130 over the Physical Downlink Control Channel (PDCCH). The second network node 112 may send a paging message with the Physical Downlink Shared Channel (PDSCH), which may include the paging record as well as the third indication as the MT-indication. The MT-indication in the paging message from the second network node 112 to the wireless device 130 over Uu interface may only be included if the second network node 112 determines that the MT-SDT procedure may be performed. If not, the third indication may be excluded and the legacy procedure may be followed. Upon reception of the MT-indication, the wireless device 130 may resume the data radio bearers, and the data radio bearer (DRB) for which SDT may be configured. In Step 3, the wireless device 130 may send a RA preamble, particularly, a CFRA preamble to the second network node 112. In response, in Step 4, the second network node 112 may send a RA response to the wireless device 130 with the PDCCH and PDSCH. The wireless device 130 may the initiate RRC resumption. At Step 5, the second network node 112 may receive an RRCResumeRequest over PUSCH from the wireless device 130. The second network node 112 may then, in Step 6, send a Retrieve UE Context Request to the first network node 111. In Step 7, the first network node 111 may send a Retrieve UE Context response to the second network node 112, which may comprise the DL data. The second network node 112 may send a Hybrid Automatic Repeat Request (HARQ) Acknowledgement (Ack) to the wireless device 130. The second network node 112 may then, in Step 8, send an RRC Release message with the DL data to the wireless device 130 over PDCCH and PDSCH.

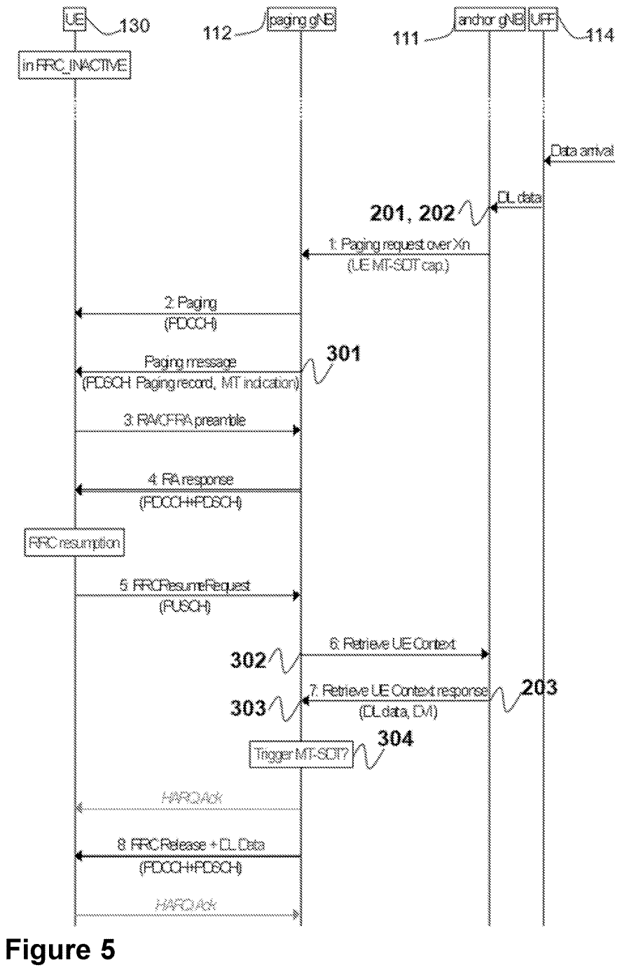

FIG. 5 is a schematic representation depicting a non-limiting example of embodiments herein, as described in relation to FIG. 2 and FIG. 3. As depicted in FIG. 5, data may arrive for delivery to the wireless device 130, which may be in inactive state. In this example, in RRC_inactive state. In this example, the data may arrive at the fourth network node 114, in this example, a UPF. The fourth network node 114 may deliver the DL data to the first network node 111 storing a context for the wireless device 130, that is, the anchor network node, which in this example is an anchor gNB. The first network node 111 may obtain the data according to Action 201 and, according to Action 202, refrain from determining whether or not to trigger the MT-SDT procedure for transmission of the data towards the wireless device 130 until the first network node 111 may receive the further indication indicating whether or not the wireless device 130 is in the serving area of the first network node 111. In Step 1, the first network node 111 may send a paging request, over the Xn interface, to the second network node 112, which may comprise the second indication of the capability of the wireless device 130 to perform the MT-SDT procedure. According to embodiments herein, the first indication, here, the DVI, may instead be transmitted only to the paging gNB where the wireless device 130 may be located. That is, to the network node which may have received the random access preamble in response to the paging, which may be understood to be the second network node 112. This may be understood as an approach with delayed DVI in relation to the baseline approach depicted in FIG. 4. In this case, the second network node 112 may not immediately determine if the MT-SDT procedure may be used or not, based on whether the wireless device 130 may be MT-SDT capable, and the size of the data payload. Instead, the second network node 112 may take the capability of the wireless device 130 for MT-SDT into consideration and continue a generic paging procedure. In Step 2, the second network node 112 may page the wireless device 130 over the Physical Downlink Control Channel (PDCCH). The second network node 112 may send a paging message with the Physical Downlink Shared Channel (PDSCH), which may include the paging record as well as the third indication as the MT-indication. The third indication, MT-indication or resumption indication, may be included in the paging message still to indicate that the wireless device 130 may have to resume radio bearers early, e.g., as done for Rel-17 MO-SDT when they may be resumed as part of the procedure to transmit the RRCResumeRequest, that is, early compared to legacy connection establishment without SDT. If MT-SDT is not used, this may be understood to mean that the legacy connection establishment may be followed by the wireless device 130, but that radio bearers may be resumed earlier, which may have a minimal impact on the procedure, not that this may be the case only for MT-SDT capable wireless devices. In an alternative approach, the third indication, e.g., the MT-indication, may always be omitted, but MT-SDT capable wireless devices may always resume radio bearers early if the cell supports MT-SDT according to an indication in system information, or explicit from the MT-SDT configuration in the cell. Steps 3-5 may be understood to be the same as those described in FIG. 4. In Step 6, the second network node 112 may, according to Action 302, send the request for the context to the first network node 111 with the proviso that the second network node 112 has received the random access preamble from the wireless device 130. In Step 7, the first network node 111 may then, in accordance with Action 203, append the first indication, here, the DVI along with the DL data, to the UE context transmitted in response to the UE context request from the second network node 112, where the wireless device 130 was located. The second network node 112 may receive the first indication in accordance with Action 303. Based on comparison of this DVI to the MT-SDT data volume threshold configured in the second cell 122, the second network node 112 may then, according to Action 304, decide to use MT-SDT or not. In this case, this may correspond to the second network node 112, multiplexing the RRCRelease with the DL data payload in Step 8, or transmitting the DL data only, in case further UL transmissions may be expected. The second network node 112 may have, after the determination and before Step 8, sent a HARQ Ack to the wireless device 130. The wireless device 130 may send a HARQ Ack to the second network node 112. If MT-SDT is not used, the second network node 112 may instead respond with RRCResume and resume the previous connection. Subsequent DL data transmission are not considered here. The above description is based on using legacy RA as the response to paging, but the approach may work similarly also with using RA-SDT or CG-SDT, as the response as stated in the work item objective.

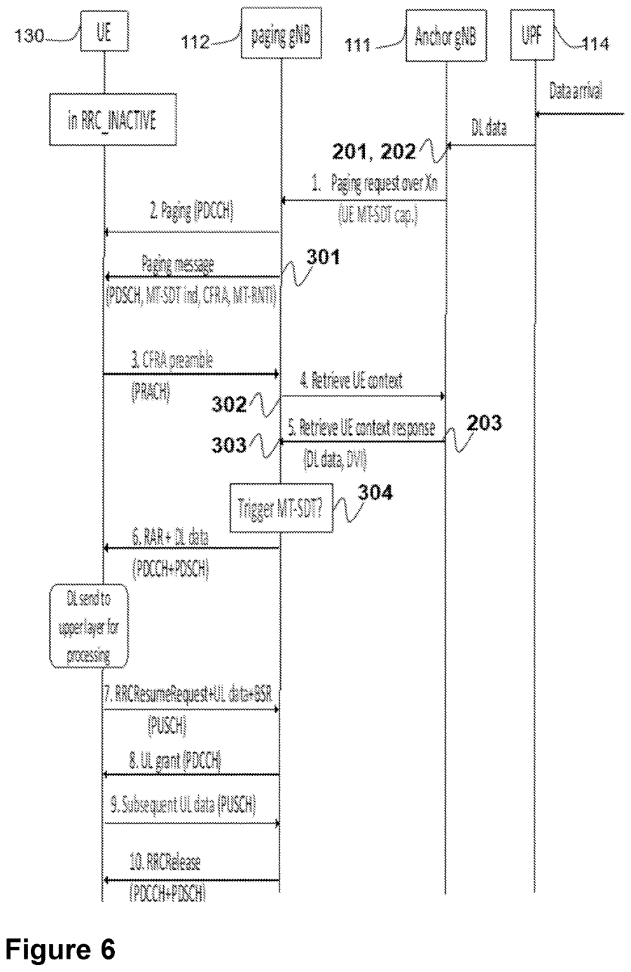

FIG. 6 is a schematic representation depicting another non-limiting example of embodiments herein, as described in relation to FIG. 2 and FIG. 3. The description of FIG. 6 up to Step 2 may be understood to be the same as for FIG. 5. In Step 2, the second network node 112 may page the wireless device 130 over the Physical Downlink Control Channel (PDCCH). The second network node 112 may send a paging message with the Physical Downlink Shared Channel (PDSCH), which may include the paging record as well as the third indication as the MT-indication, the CFRA and the MT-RNTI. In Step 3, the wireless device 130 may send the CFRA preamble over the PRACH to the second network node 112. In an alternate example to that depicted in FIG. 5, the second network node 112 may, in Step 4, according to Action 302, initiates a transfer of the context of the wireless device 130 once the wireless device 130 may send the CFRA preamble in Step 3 as shown in FIG. 6. In Step 5, the first network node 111 may then, in accordance with Action 203, append the first indication, here, the DVI along with the DL data to the UE context transmitted in response to the UE context request from the second network node 112, where the wireless device 130 was located. That is, in the example of FIG. 6, appending the DVI along with UE context transfer may be performed once the second network node 112 may receive a paging triggered CFRA preamble from the wireless device 130. The second network node 112 may receive the first indication in accordance with Action 303. In this case, the wireless device 130 may also resume the RBs when transmitting the CFRA preamble. When the second network node 112 receives the CFRA preamble, it may send a request to the first network node 111 to retrieve the context of the wireless device 130. Compared to the cases when the legacy Retrieve UE Context message may be sent, some changes to the legacy message or a new message may be needed, since the paging may be understood to not have received the RRCResumeRequest from the wireless device 130 which may be needed to construct the Retrieve UE context request such as the ResumeMAC-I. From the paging message, the I-RNTI identifying the context of the wireless device 130 may be known, and this may form the basis of this new message. Based on the retrieved context and the DVI from the first network node 111, the second network node 112 may decide, according to Action 304, whether or not to initiate the MT-SDT procedure, by comparing the configured MT-SDT data volume threshold. This may enable the second network node 112 to decide whether to append the DL data with RA response as part of MT-SDT procedure. Upon context retrieval, the MT-SDT data radio bearers may be re-established. A larger TBS may also be provided to the wireless device 130 for transmitting the RRCResumeRequest, which may enable the transmission of UL data as DL response as part of RA/CG/legacy procedure. In Step 6, the second network node 112 may send a RAR to the wireless device 130 along with the DL data, over the PDCCH and the PDSCH. Accordingly, the approach depicted in FIG. 6 may be understood to be an approach with delayed DVI, in relation to the baseline approach depicted in FIG. 4, for Data in Msg2. Upon receipt of the RAR, the wireless device 130 may the send the data to the upper layer for processing. In Step 7, the wireless device 130 may send an RRCResumeRequest to the second network node 112, along with UL data and a BSR, over the PUSCH. In Step 8, the second network node 112 may send an UL grant to the wireless device 139 over the PDCCH. In Step 9, the wireless device 130 may send subsequent UL data to the second network node 112 over the PUSCH. In Step 10, the second network node 112 may send an RRCRelease to the wireless device 130 over the PDCCH and the PDSCH.

Certain embodiments disclosed herein may provide one or more of the following technical advantage(s), which may be summarized as follows. Embodiments herein may enable to minimize signaling over Xn.

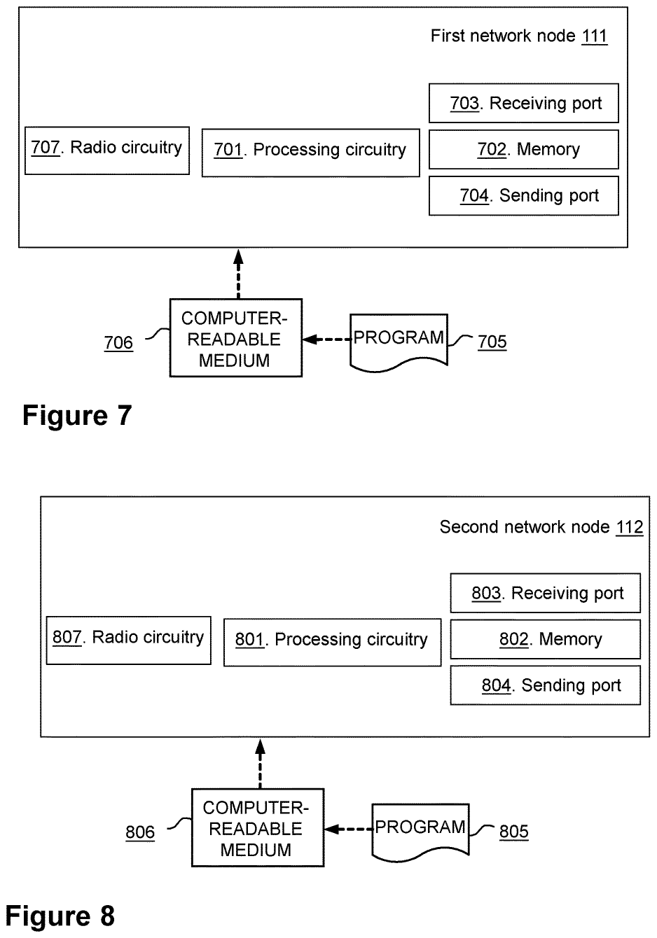

FIG. 7 depicts an example of the arrangement that the first network node 111 may comprise to perform the method described in FIG. 2 and/or FIGS. 5-6. The first network node 111 may be understood to be for handling downlink transmission for the wireless device 130. The first network node 111 is configured to operate in the RAN 110 of the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 111, and will thus not be repeated here. For example, the RA preamble may be configured to be a CFRA preamble.

The first network node 111 is configured to, e.g. by means of an obtaining unit within the first network node 111 configured to, obtain the data for downlink transmission to the wireless device 130. The first network node 111 is configured to have the context stored for the connection with the wireless device 130. The wireless device 130 is configured to be in the inactive state.

The first network node 111 is also configured to, e.g. by means of a sending unit configured to, send the first indication to the second network node 112. The second network node 112 is configured to operate in the RAN 110 of the wireless communications network 100 and to page or be paging the wireless device 130 for transmission of the data. The first indication is configured to indicate the size of the buffer of the data for downlink transmission to the wireless device 130. The first network node 111 is configured to refrain from sending the first indication to the other network nodes 113 configured to operate in the RAN 110 of the wireless communications network 100 and configured to be paging the wireless device 130 for transmission of the data. The sending of the first indication is configured to be performed with the proviso that the previous indication is configured to have been obtained from the second network node 112 indicating the wireless device 130 is in the serving area of the second network node 112.

In some embodiments, the first indication may be configured to be sent to the second network node 112 in one of: a) the paging request, b) the paging request, wherein the paging request may be configured to trigger the paging by the second network node 112 of the wireless device 130, c) the paging request, wherein the paging request may be further configured to comprise the second indication of the capability of the wireless device 130 to perform the MT-SDT procedure, d) before sending the another indication of the context of the wireless device 130, and e) along with the another indication of the context of the wireless device 130 in the response to the request for the context received from the second network node 112.

The first network node 111 may be further configured to, e.g. by means of a receiving unit within the first network node 111 configured to, refrain from determining whether or not to trigger the MT-SDT procedure for transmission of the data towards the wireless device 130, until the first network node 111 receives the further indication configured to indicate whether or not the wireless device 130 is in the serving area of the first network node 111.

In some embodiments, the further indication may be configured to be the previous indication configured to indicate the wireless device 130 may be in the serving area of the second network node 112.

In some embodiments, at least one of the following may apply: i) the first indication may be configured to be the data volume indicator, ii) the obtaining may be configured to be from the fourth network node 114, iii) the fourth network node 114 may be configured to be the core network node, iv) the inactive state may be configured to be the RRC inactive state, v) the first network node 111 may be configured to be the anchor network node, vi) the second network node 112 may be configured to be the paging network node, vii) the wireless communications network 100 may be configured to be a Fifth Generation network, viii) the first network node 111 may be configured to be the first gNB, ix) the second network node 112 may be configured to be the second gNB, and x) the wireless device 130 may be configured to be a UE.

The embodiments herein in the first network node 111 may be implemented through one or more processors, such as a processing circuitry 701 in the first network node 111 depicted in FIG. 7, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 702 comprising one or more memory units. The memory 702 is arranged to be used to store obtained information, store data, configurations, schedulings, and applications etc. to perform the methods herein when being executed in the first network node 111.

In some embodiments, the first network node 111 may receive information from, e.g., the second network node 112, the other network nodes 113, the fourth network node 114 and/or another structure in the computer system 100, through a receiving port 703. In some embodiments, the receiving port 703 may be, for example, connected to one or more antennas in first network node 111. In other embodiments, the first network node 111 may receive information from another structure in the computer system 100 through the receiving port 703. Since the receiving port 703 may be in communication with the processing circuitry 701, the receiving port 703 may then send the received information to the processing circuitry 701. The receiving port 703 may also be configured to receive other information.

The processing circuitry 701 in the first network node 111 may be further configured to transmit or send information to e.g., the second network node 112, the other network nodes 113, the fourth network node 114 and/or another structure in the computer system 100, through a sending port 704, which may be in communication with the processing circuitry 701, and the memory 702.

Those skilled in the art will also appreciate that the units comprised within the first network node 111 described above as being configured to perform different actions, may refer to a combination of analog and digital circuits, and/or one or more processors configured with software and/or firmware, e.g., stored in memory, that, when executed by the one or more processors such as the processing circuitry 701, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first network node 111 described above as being configured to perform different actions described above may be implemented as one or more applications running on one or more processors such as the processing circuitry 701.

Thus, the methods according to the embodiments described herein for the first network node 111 may be respectively implemented by means of a computer program 705 product, comprising instructions, i.e., software code portions, which, when executed on at least one processing circuitry 701, cause the at least one processing circuitry 701 to carry out the actions described herein, as performed by the first network node 111. The computer program 705 product may be stored on a computer-readable storage medium 706. The computer-readable storage medium 706, having stored thereon the computer program 705, may comprise instructions which, when executed on at least one processing circuitry 701, cause the at least one processing circuitry 701 to carry out the actions described herein, as performed by the first network node 111. In some embodiments, the computer-readable storage medium 706 may be a non-transitory computer-readable storage medium, such as a CD ROM disc, or a memory stick. In other embodiments, the computer program 705 product may be stored on a carrier containing the computer program 705 just described, wherein the carrier is one of an electronic signal, optical signal, radio signal, or the computer-readable storage medium 706, as described above.

The first network node 111 may comprise a communication interface configured to facilitate, or an interface unit to facilitate, communications between the first network node 111 and other nodes or devices, e.g., the second network node 112, the other network nodes 113, the fourth network node 114 and/or another structure in the computer system 100. The interface may, for example, include a transceiver configured to transmit and receive radio signals over an air interface in accordance with a suitable standard.

In other embodiments, the first network node 111 may comprise a radio circuitry 707, which may comprise e.g., the receiving port 703 and the sending port 704.

The radio circuitry 707 may be configured to set up and maintain at least a wireless connection with any of the second network node 112, the other network nodes 113, the fourth network node 114 and/or another structure in the computer system 100. Circuitry may be understood herein as a hardware component.

Hence, embodiments herein also relate to the first network node 111 operative to operate in the computer system 100. The first network node 111 may comprise the processing circuitry 701 and the memory 702, said memory 702 containing instructions executable by said processing circuitry 701, whereby the first network node 111 is further operative to perform the actions described herein in relation to the first network node 111, e.g., in FIG. 2 and/or FIGS. 5-6.

A similar arrangement may be operative to perform the actions described herein in relation to FIG. 4.

FIG. 8 depicts an example of the arrangement that the second network node 112 may comprise to perform the method described in FIG. 3 and/or FIGS. 5-6. The second network node 112 may be understood to be for handling downlink transmission for the wireless device 130. The second network node 112 is configured to operate in the RAN 110 of the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second network node 112, and will thus not be repeated here. For example, the RA preamble may be configured to be a CFRA preamble.

The second network node 112 is configured to, e.g. by means of a receiving unit within the second network node 112 configured to, receive the first indication from the first network node 111 configured to operate in the RAN 110 of the wireless communications network 100. The first indication is configured to indicate the size the buffer of data for the downlink transmission to the wireless device 130. The wireless device 130 is configured to be located in the serving area of the second network node 112. The wireless device 130 is configured to be in the inactive state. The receiving of the first indication is configured to be performed with the proviso that the previous indication is configured to have been sent by the second network node 112. The previous indication is configured to indicate that the wireless device 130 is in the serving area of the second network node 112.

The second network node 112 may also configured to, e.g. by means of a sending unit configured to, send, based on the second indication configured to be received, the second indication being configured to indicate the capability of the wireless device 130 to perform the MT-SDT transmission procedure, the third indication to the wireless device 130. The third indication may be configured to indicate that the wireless device 130 is to resume radio bearers.

The second network node 112 may be further configured to, e.g. by means of a determining unit within the second network node 112 configured to, determine, after having received the paging request from the first network node 111 and based on the size of the data and the first indication, whether or not to trigger the MT-SDT transmission procedure for transmission of the data towards the wireless device 130.

The second network node 112 may also configured to, e.g. by means of a sending unit configured to, send the request for the context to the first network node 111 with the proviso that the second network node 112 may be configured to have received the random access preamble from the wireless device 130.

In some embodiments, the first indication may be configured to be received by the second network node 112 in one of: a) the paging request, b) the paging request, wherein the paging request may be configured to trigger the paging by the second network node 112 of the wireless device 130, c) the paging request, wherein the paging request may be further configured to comprise the second indication of the capability of the wireless device 130 to perform the MT-SDT procedure, d) before sending the another indication of the context of the wireless device 130, and e) along with the another indication of the context of the wireless device 130 in the response to the request for the context configured to be sent by the second network node 112.

In some embodiments at least one of the following may apply: a) the first indication may be configured to be received by the second network node 112 along with the context of the wireless device 130 in the response to the request for the context configured to be sent by the second network node 112, and the second network node 112 may be configured to perform the determining after the receiving of the first indication, and b) the sending of the request may be configured to be performed in the absence of having received another request from the wireless device 130 to resume the connection.

In some embodiments, at least one of the following may apply: i) the first indication may be configured to be the data volume indicator, ii) the inactive state may be configured to be the RRC inactive state, iii) the first network node 111 may be configured to be the anchor network node, iv) the second network node 112 may be configured to be the paging network node, v) the wireless communications network 100 may be configured to be a Fifth Generation network, vi) the first network node 111 may be configured to be the first gNB, vii) the second network node 112 may be configured to be the second gNB, and x) the wireless device 130 may be configured to be a UE.

The embodiments herein in the second network node 112 may be implemented through one or more processors, such as a processing circuitry 801 in the second network node 112 depicted in FIG. 8, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second network node 112. One such carrier may be in the form of a CD ROM disc. It is however feasible with other data carriers such as a memory stick. The computer program code may furthermore be provided as pure program code on a server and downloaded to the second network node 112.

The second network node 112 may further comprise a memory 802 comprising one or more memory units. The memory 802 is arranged to be used to store obtained information, store data, configurations, schedulings, and applications etc. to perform the methods herein when being executed in the second network node 112.

In some embodiments, the second network node 112 may receive information from, e.g., the second network node 112, the other network nodes 113, the fourth network node 114 and/or another structure in the computer system 100, through a receiving port 803. In some embodiments, the receiving port 803 may be, for example, connected to one or more antennas in second network node 112. In other embodiments, the second network node 112 may receive information from another structure in the computer system 100 through the receiving port 803. Since the receiving port 803 may be in communication with the processing circuitry 801, the receiving port 803 may then send the received information to the processing circuitry 801. The receiving port 803 may also be configured to receive other information.

The processing circuitry 801 in the second network node 112 may be further configured to transmit or send information to e.g., the second network node 112, the other network nodes 113, the fourth network node 114 and/or another structure in the computer system 100, through a sending port 804, which may be in communication with the processing circuitry 801, and the memory 802.

Those skilled in the art will also appreciate that the units comprised within the second network node 112 described above as being configured to perform different actions, may refer to a combination of analog and digital circuits, and/or one or more processors configured with software and/or firmware, e.g., stored in memory, that, when executed by the one or more processors such as the processing circuitry 801, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second network node 112 described above as being configured to perform different actions described above may be implemented as one or more applications running on one or more processors such as the processing circuitry 801.

Thus, the methods according to the embodiments described herein for the second network node 112 may be respectively implemented by means of a computer program 805 product, comprising instructions, i.e., software code portions, which, when executed on at least one processing circuitry 801, cause the at least one processing circuitry 801 to carry out the actions described herein, as performed by the second network node 112. The computer program 805 product may be stored on a computer-readable storage medium 806. The computer-readable storage medium 806, having stored thereon the computer program 805, may comprise instructions which, when executed on at least one processing circuitry 801, cause the at least one processing circuitry 801 to carry out the actions described herein, as performed by the second network node 112. In some embodiments, the computer-readable storage medium 806 may be a non-transitory computer-readable storage medium, such as a CD ROM disc, or a memory stick. In other embodiments, the computer program 805 product may be stored on a carrier containing the computer program 805 just described, wherein the carrier is one of an electronic signal, optical signal, radio signal, or the computer-readable storage medium 806, as described above.

The second network node 112 may comprise a communication interface configured to facilitate, or an interface unit to facilitate, communications between the second network node 112 and other nodes or devices, e.g., the second network node 112, the other network nodes 113, the fourth network node 114 and/or another structure in the computer system 100. The interface may, for example, include a transceiver configured to transmit and receive radio signals over an air interface in accordance with a suitable standard.

In other embodiments, the second network node 112 may comprise a radio circuitry 807, which may comprise e.g., the receiving port 803 and the sending port 804.

The radio circuitry 807 may be configured to set up and maintain at least a wireless connection with any of the second network node 112, the other network nodes 113, the fourth network node 114 and/or another structure in the computer system 100. Circuitry may be understood herein as a hardware component.

Hence, embodiments herein also relate to the second network node 112 operative to operate in the computer system 100. The second network node 112 may comprise the processing circuitry 801 and the memory 802, said memory 802 containing instructions executable by said processing circuitry 801, whereby the second network node 112 is further operative to perform the actions described herein in relation to the second network node 112, e.g., in FIG. 2 and/or FIGS. 5-6.

A similar arrangement may be operative to perform the actions described herein in relation to FIG. 4.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise.

The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### Further Extensions and Variations

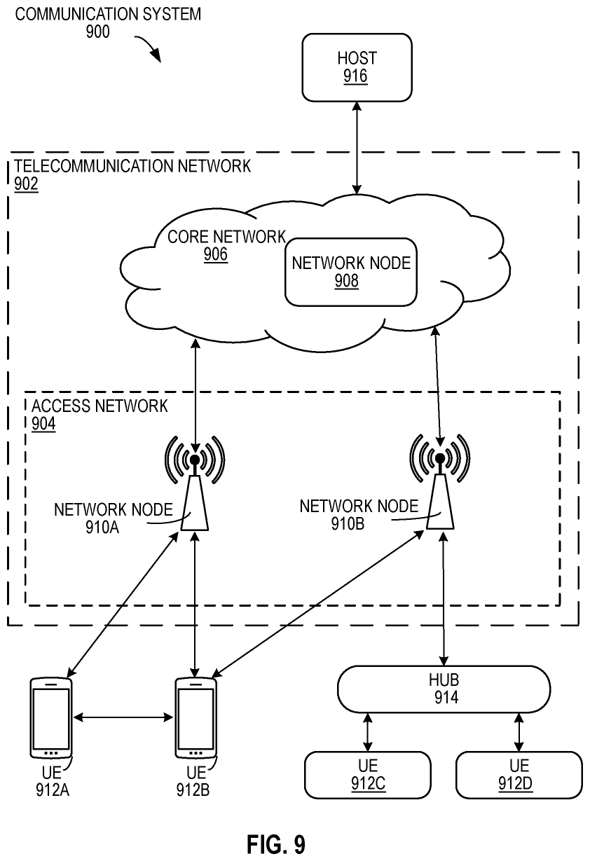

FIG. 9 shows an example of a communication system 900 in accordance with some embodiments.

In the example, the communication system 900, such as the wireless communications network 100, includes a telecommunication network 902 that includes an access network 904, such as a radio access network (RAN), and a core network 906, which includes one or more core network nodes 908. The access network 904 includes one or more access network nodes, such as any of the first network node 111, the second network node 112, the other network nodes 113 and the fourth network node 114. For example, network nodes 910a and 910b, one or more of which may be generally referred to as network nodes 910, or any other similar 3^{rd} Generation Partnership Project (3GPP) access node or non-3GPP access point. The communications system 900 comprises a plurality of wireless devices, such as the wireless device 130. In FIG. 9, the plurality of wireless devices comprises UEs 912a, 912b, 912c, and 912d, one or more of which may be generally referred to as UEs 912. The network nodes 910 facilitate direct or indirect connection of user equipment (UE), such as by connecting UEs 912a, 912b, 912c, and 912d to the core network 906 over one or more wireless connections. Any of the UEs 912a, 912b, 912c, and 912d are examples of the wireless device 130.

In relation to FIGS. 9, 10, and 11, which are described next, it may be understood that any UE is an example of the wireless device 130, and that any description provided for the UE 912 or for the UE 1106 equally applies to the wireless device 130. It may be also understood that any network node is an example of any of the first network node 111, the second network node 112, the other network nodes 113 and the fourth network node 114, and that any description provided for any network node 910 or for the network node 1104 equally applies to any of the first network node 111, the second network node 112, the other network nodes 113 and the fourth network node 114. It may further be understood that the communication system 900 is an example of the wireless communication network 100, and that any description provided for the communication system 900 equally applies to the wireless communication network 100.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The wireless device 130, exemplified in FIG. 9 as the UEs 912, may be any of a wide variety of communication devices, including wireless devices arranged, configured, and/or operable to communicate wirelessly with any of the first network node 111, the second network node 112, the other network nodes 113 and the fourth network node 114, exemplified in FIG. 9 as network nodes 910, and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes, e.g., core network node 908, that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902 and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, New Radio (NR) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs, e.g., UE 912c and/or 912d, and network nodes, e.g., network node 910b. In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub-that is, a hub whose primary function is to route communications to/from the UEs from/to the network node 910b. In other embodiments, the hub 914 may be a non-dedicated hub-that is, a device which is capable of operating to route communications between the UEs and network node 910b, but which is additionally capable of operating as a communication start and/or end point for certain data channels.

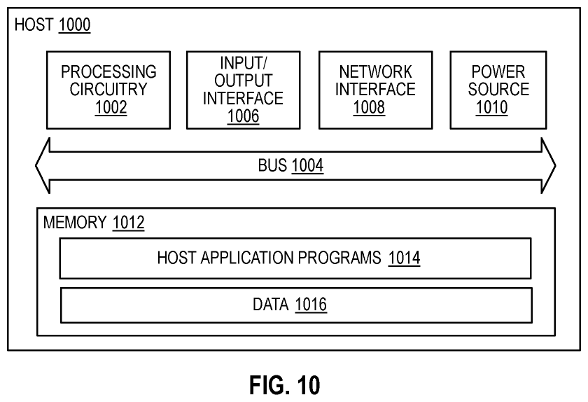

FIG. 10 is a block diagram of a host 1000, which may be an embodiment of the host 916 of FIG. 9, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs, (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

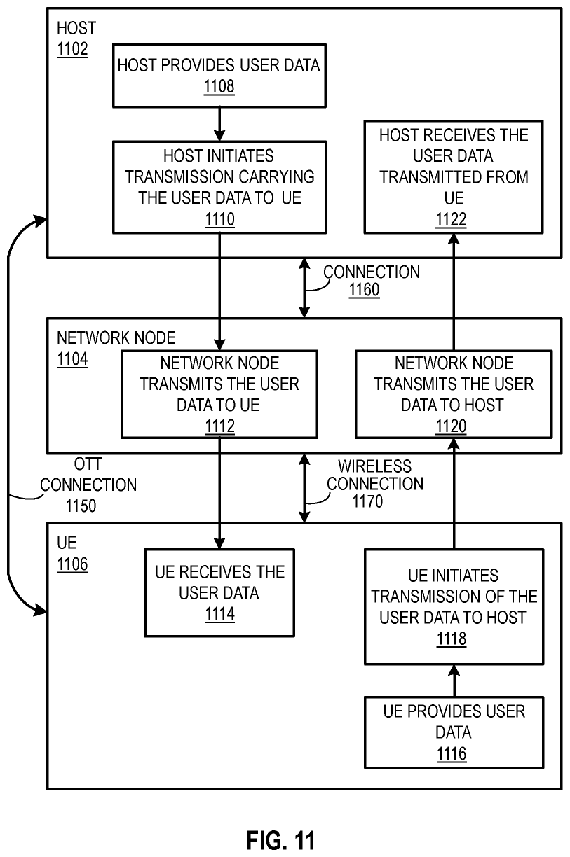

FIG. 11 shows a communication diagram of a host 1102 communicating via a network node 1104 with a UE 1106 over a partially wireless connection in accordance with some embodiments. Example implementations, in accordance with various embodiments, of the UE, such as a UE 912a of FIG. 9, network node, such as network node 910a of FIG. 9, and host, such as host 916 of FIG. 9 and/or host 1000 of FIG. 10, discussed in the preceding paragraphs will now be described with reference to FIG. 11.

Like host 1000, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 906 of FIG. 9) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion, e.g., controlling traffic lights. As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors, not shown, may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

### Further Numbered Embodiments

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by any of the first network node 111, the second network node 112, the other network nodes 113 and the fourth network node 114.
2. The host of the previous embodiment, wherein:
the processing circuitry of the host is configured to execute a host application that provides the user data; and
the UE comprises processing circuitry configured to execute a client application associated with the host application to receive the transmission of user data from the host.
3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by any of the first network node 111, the second network node 112, the other network nodes 113 and the fourth network node 114.
4. The method of the previous embodiment, further comprising, at the network node, transmitting the user data provided by the host for the UE.
5. The method of any of the previous 2 embodiments, wherein the user data is provided at the host by executing a host application that interacts with a client application executing on the UE, the client application being associated with the host application.
6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by any of the first network node 111, the second network node 112, the other network nodes 113 and the fourth network node 114.
7. The communication system of the previous embodiment, further comprising:
the network node; and/or
the user equipment.
8. The communication system of the previous 2 embodiments, wherein:
the processing circuitry of the host is configured to execute a host application, thereby providing the user data; and
the host application is configured to interact with a client application executing on the UE, the client application being associated with the host application.
9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by any of the first network node 111, the second network node 112, the other network nodes 113 and the fourth network node 114.
10. The host of the previous 2 embodiments, wherein:
the processing circuitry of the host is configured to execute a host application, thereby providing the user data; and
the host application is configured to interact with a client application executing on the UE, the client application being associated with the host application.
11. The host of the any of the previous 2 embodiments, wherein the initiating receipt of the user data comprises requesting the user data.
12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by any of the first network node 111, the second network node 112, the other network nodes 113 and the fourth network node 114.
13. The method of the previous embodiment, further comprising at the network node, transmitting the received user data to the host.
14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the wireless device 130.
15. The host of the previous embodiment, wherein the cellular network further includes a network node configured to communicate with the UE to transmit the user data to the UE from the host.
16. The host of the previous 2 embodiments, wherein:
the processing circuitry of the host is configured to execute a host application, thereby providing the user data; and
the host application is configured to interact with a client application executing on the UE, the client application being associated with the host application.
17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the wireless device 130.
18. The method of the previous embodiment, further comprising:
at the host, executing a host application associated with a client application executing on the UE to receive the user data from the UE.
19. The method of the previous embodiment, further comprising:
at the host, transmitting input data to the client application executing on the UE, the input data being provided by executing the host application,
wherein the user data is provided by the client application in response to the input data from the host application.
20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the wireless device 130.
21. The host of the previous embodiment, wherein the cellular network further includes a network node configured to communicate with the UE to transmit the user data from the UE to the host.
22. The host of the previous 2 embodiments, wherein:
the processing circuitry of the host is configured to execute a host application, thereby providing the user data; and
the host application is configured to interact with a client application executing on the UE, the client application being associated with the host application.
23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the wireless device 130.
24. The method of the previous embodiment, further comprising:
at the host, executing a host application associated with a client application executing on the UE to receive the user data from the UE.
25. The method of the previous embodiments, further comprising:
at the host, transmitting input data to the client application executing on the UE, the input data being provided by executing the host application,
wherein the user data is provided by the client application in response to the input data from the host application.

1-20. (canceled)

21. A method performed by a first network node, the method being for handling downlink transmission for a wireless device, the first network node operating in a Radio Access Network (RAN) of a wireless communications network, and the method comprising:
obtaining data for downlink transmission to the wireless device, wherein the first network node has a context stored for a connection with the wireless device, wherein the wireless device is in an inactive state, and
sending a first indication to a second network node operating in the RAN of the wireless communications network and to page or be paging the wireless device for transmission of the data, wherein the first indication indicates a size of a buffer of the data for downlink transmission to the wireless device, and wherein:
i. the first network node refrains from sending the first indication to other network nodes operating in the RAN of the wireless communications network and paging the wireless device for transmission of the data, and
ii. the sending of the first indication is performed with the proviso that a previous indication has been obtained from the second network node indicating the wireless device is in the serving area of the second network node.

22. The method of claim 21, wherein the first indication is sent to the second network node in one of:
a paging request,
the paging request, wherein the paging request triggers the paging by the second network node of the wireless device,
the paging request, wherein the paging request further comprises a second indication of a capability of the wireless device to perform a mobile-terminated small data transmission procedure,
before sending another indication of the context of the wireless device, and
along with the another indication of the context of the wireless device in a response to a request for the context received from the second network node.

23. The method of claim 22, further comprising:
refraining from determining whether or not to trigger the mobile-terminated small data transmission procedure for transmission of the data towards the wireless device, until the first network node receives a further indication indicating whether or not the wireless device is in a serving area of the first network node.

24. The method of claim 33, wherein the further indication is the previous indication indicating the wireless device is in the serving area of the second network node.

25. The method of claim 21, wherein at least one of:
the first indication is a data volume indicator,
the obtaining is from a fourth network node,
the fourth network node is a core network node,
the inactive state is a Radio Resource Control (RRC) inactive state,
the first network node is an anchor network node,
the second network node is a paging network node,
the wireless communications network is a Fifth Generation network,
the first network node is a first gNB,
the second network node is a second gNB, and
the wireless device is a user equipment.

26. A method performed by a second network node, the method being for handling downlink transmission for a wireless device, the second network node operating in a Radio Access Network (RAN) of a wireless communications network, and the method comprising:
receiving a first indication from a first network node operating in the RAN of the wireless communications network, wherein the first indication indicates a size of a buffer of data for the downlink transmission to the wireless device, wherein the wireless device is located in a serving area of the second network node, wherein the wireless device is in an inactive state, and wherein the receiving of the first indication is performed with the proviso that a previous indication has been sent by the second network node indicating that the wireless device is in the serving area of the second network node.

27. The method of claim 24, further comprising at least one of:
sending, based on a received second indication indicating a capability of the wireless device to perform a mobile-terminated small data transmission procedure, a third indication to the wireless device, the third indication indicating that the wireless device is to resume radio bearers,
determining, after having received a paging request from the first network node and based on the size of the data and the first indication, whether or not to trigger the mobile-terminated small data transmission procedure for transmission of the data towards the wireless device, and
sending a request for the context to the first network node with the proviso that the second network node has received a random access preamble from the wireless device.

28. The method of claim 27, wherein the first indication is received by the second network node in one of:
the paging request,
the paging request, wherein the paging request triggers the paging by the second network node of the wireless device,
the paging request, wherein the paging request further comprises a second indication of a capability of the wireless device to perform a mobile-terminated small data transmission procedure,
before receiving another indication of the context of the wireless device, and
along with the another indication of the context of the wireless device in a response to the request for the context sent by the second network node.

29. The method of claim 28, wherein at least one of:
the first indication is received by the second network node along with the context of the wireless device in the response to the request for the context sent by the second network node, and wherein the second network node performs the determining after the receiving of the first indication, and
the sending of the request is performed in the absence of having received another request from the wireless device to resume the connection.

30. The method of claim 26, wherein at least one of:
the first indication is a data volume indicator,
the inactive state is a Radio Resource Control (RRC) inactive state, the first network node is an anchor network node, the second network node is a paging network node, the wireless communications network is a Fifth Generation network, the first network node is a first gNB, the second network node is a second gNB, and the wireless device is a user equipment.

31. A first network node, for handling downlink transmission for a wireless device, the first network node being configured to operate in a Radio Access Network (RAN) of a wireless communications network, and the first network node being further configured to:
obtain data for downlink transmission to the wireless device, wherein the first network node is configured to have a context stored for a connection with the wireless device, wherein the wireless device is configured to be in an inactive state, and send a first indication to a second network node configured to operate in the RAN of the wireless communications network and to page or paging the wireless device for transmission of the data, wherein the first indication is configured to indicate a size of a buffer of the data for downlink transmission to the wireless device, and wherein:
i. the first network node is configured to refrain from sending the first indication to other network nodes configured to operate in the RAN of the wireless communications network and configured to be paging the wireless device for transmission of the data, and ii. the sending of the first indication is configured to be performed with the proviso that a previous indication is configured to have been obtained from the second network node indicating the wireless device is in the serving area of the second network node.

32. The first network node of claim 31, wherein the first indication is configured to be sent to the second network node in one of:
a paging request, the paging request, wherein the paging request is configured to trigger the paging by the second network node of the wireless device, the paging request, wherein the paging request is further configured to comprise a second indication of a capability of the wireless device to perform a mobile-terminated small data transmission procedure, before sending another indication of the context of the wireless device, and along with the another indication of the context of the wireless device in a response to a request for the context received from the second network node.

33. The first network node of claim 32, being further configured to:
refrain from determining whether or not to trigger the mobile-terminated small data transmission procedure for transmission of the data towards the wireless device, until the first network node receives a further indication configured to indicate whether or not the wireless device is in a serving area of the first network node.

34. The first network node of claim 33, wherein the further indication is configured to be the previous indication configured to indicate the wireless device is in the serving area of the second network node.

35. The first network node of claim 33, wherein at least one of:
the first indication is configured to be a data volume indicator,
the obtaining is configured to be from a fourth network node,
the fourth network node is configured to be a core network node,
the inactive state is configured to be a Radio Resource Control (RRC) inactive state,
the first network node is configured to be an anchor network node,
the second network node is configured to be a paging network node,
the wireless communications network is configured to be a Fifth Generation network,
the first network node is configured to be a first gNB,
the second network node is configured to be a second gNB, and
the wireless device is configured to be a user equipment.

36. A second network node, for handling downlink transmission for a wireless device, the second network node being configured to operate in a Radio Access Network (RAN) of a wireless communications network, and the second network node being further configured to:
receive a first indication from a first network node configured to operate in the RAN of the wireless communications network, wherein the first indication is configured to indicate a size of a buffer of data for the downlink transmission to the wireless device, wherein the wireless device is configured to be located in a serving area of the second network node, wherein the wireless device is configured to be in an inactive state, and wherein the receiving of the first indication is configured to be performed with the proviso that a previous indication is configured to have been sent by the second network node, wherein the previous indication is configured to indicate that the wireless device is in the serving area of the second network node.

37. The second network node of claim 36, being further configured to at least one of:
send, based on a second indication configured to be received, the second indication being configured to indicate a capability of the wireless device to perform a mobile-terminated small data transmission procedure, a third indication to the wireless device, the third indication being configured to indicate that the wireless device is to resume radio bearers,
determine, after having received a paging request from the first network node and based on the size of the data and the first indication, whether or not to trigger the mobile-terminated small data transmission procedure for transmission of the data towards the wireless device, and
send a request for the context to the first network node with the proviso that the second network node is configured to have received a random access preamble from the wireless device.

38. The second network node of claim 37, wherein the first indication is configured to be received by the second network node in one of:
the paging request,
the paging request, wherein the paging request is configured to trigger the paging by the second network node of the wireless device,
the paging request, wherein the paging request is further configured to comprise a second indication of a capability of the wireless device to perform a mobile-terminated small data transmission procedure,
before receiving another indication of the context of the wireless device, and
along with the another indication of the context of the wireless device in a response to the request for the context configured to be sent by the second network node.

39. The second network node of claim 38, wherein at least one of:
the first indication is configured to be received by the second network node along with the context of the wireless device in the response to the request for the context configured to be sent by the second network node, and wherein the second network node is configured to perform the determining after the receiving of the first indication, and
the sending of the request is configured to be performed in the absence of having received another request from the wireless device to resume the connection.

40. The second network node of claim 36, wherein at least one of:
the first indication is configured to be a data volume indicator,
the inactive state is configured to be a Radio Resource Control (RRC) inactive state,
the first network node is configured to be an anchor network node,
the second network node is configured to be a paging network node,
the wireless communications network is configured to be a Fifth Generation network,
the first network node is configured to be a first gNB,
the second network node is configured to be a second gNB, and
the wireless device is configured to be a user equipment.
